(19) United States
(12) Patent Application Publication
(10) Pub. No.: US 2007/0071648 A1
(43) Pub. Date: Mar. 29, 2007

(54) Apparatus and method for examining a liquid sample

(75) Inventors: Heinz Werner Busch, Konigswinter-Thomasberg (DE); Udo Heinrich Grabowy, Euskirchen-Flamersheim (DE)

Correspondence Address: BROWDY AND NEIMARK, P.L.L.C.;624 NINTH STREET, NW, SUITE 300, WASHINGTON, DC, 20001-5303, US

(73) Assignee: RAUMEDIC AG, HELMBRECHTS (DE)

(21) Appl. No.: 10/580,028

(22) PCT Filed: Nov. 18, 2004
(86) PCT No.: PCT/EP04/13084

§ 371 Date: May 19, 2006

Related U.S. Application Data
(60) Provisional application No. 60/523,488, filed on Nov. 19, 2003.

(30) Foreign Application Priority Data
Sep. 22, 2004 (DE) 10 2004 045816.2

(51) Int. Cl. G01N 21/00

(52) U.S. Cl. 422/82.05

(57) ABSTRACT

An apparatus for examining a liquid sample by titration, comprising a light source (2), a light sensor (3), a measuring head (1) which can be immersed into the liquid sample to be examined with an optical fibre, which receives light from the light source (2) and conveys it to the light sensor (3), wherein the measuring head (1) has a recess (5) with an interruption in the optical fibre into which the liquid to be examined penetrates when a measuring head (1) is immersed and wherein the optical fibre can be separated from the light source (2) and the light sensor (3).

The invention relates to an apparatus and a method for examining a liquid sample, in particular a urine sample, for determining the risk of urinary lithiasis.

The risk of becoming ill with urinary lithiasis is 5 to 15% on average in industrialised countries: peak values of approximately 20% are reached in the Gulf States. Epidemiological data show an increasing tendency in the incidence and in the prevalence of calculosis. 75% of calculi formed in the industrial countries consist of calcium oxalate.

A patient who has already suffered from a calculus once without therapy or with unsuitable therapy should expect a probability of recidivism of 75-100%. The need for a suitable method for determining the risk of uroliths may be derived from this. This is particularly important for determining the risk of recidivism in patients who are already ill.

A method developed at the urological clinic of Bonn University and based on a calculation of what is known as the Bonn risk index (BRI) has proven suitable for determining a urolith risk indicator. To calculate the BRI, a 40-millimolar ammonium oxalate solution is added to a urine sample by a standard method until calcium oxalate crystallisation commences. The millimolar concentration of oxalate (Ox²⁻) added to the urine sample at this moment is determined and related to a sample volume of 200 ml. In specialist medical circles, the concentration of oxalate (Ox²⁻) based on a sample volume of 200 ml is described as the added amount of oxalate (Ox²⁻). In addition, the initial concentration of free calcium ions in the urine sample [Ca²⁺] is determined: the concentration is given in mmol/l. The BRI is then calculated as
BRI=[Ca²⁺]/(Ox²⁻).

A BRI of 1/L is considered to be the risk limit for calcium oxalate lithiasis. All problems are allocated one of eight risk categories, I-VIII. BRI 1/L falls between risk categories IV and V. In a variation of the measurement method, the risk of calcium phosphate lithiasis can also be determined, a phosphate solution, rather than the ammonium oxalate solution, being presented to the urine sample until it crystallises and the ratio of free calcium ions and phosphate solution being determined as the risk indicator.

The object of the invention is to provide an apparatus and a method for examining liquid samples with which, in particular, the above-described method of examination of a urine sample for determining the Bonn risk index may be carried out cost-effectively and reliably in a medical practice or in a hospital. The apparatus should enable the method to be carried out in a standard, substantially automated manner and at low cost.

The inventors have found that a titration system may be used in conjunction with optical transition measurement to determine the crystallisation point of a liquid sample. However, the measuring arrangement for transmission measurement could not, in turn, necessitate the exclusive use of sample vessels for the liquid sample, in particular for a urine sample, of high optical quality. The inventors have concluded from this that although a portion of the liquid sample is to be investigated thoroughly with a light ray for transmission measurement, it is, on the other hand, disadvantageous to pass rays through the sample vessel itself.

According to the invention, therefore, the apparatus comprises a measuring head which comprises an optical fibre and may be immersed into a liquid sample to be measured. A first end of the optical fibre is allocated to a light source. A light sensor is arranged in a defined manner relative to the light path, predetermined by the optical fibre, of the light emitted from the light source. In the immersed region of the measuring head there is further provided a recess which further interrupts the optical fibre in such a way that at least a portion of the light guided by the optical fibre thoroughly examines the liquid sample over a defined distance. Clouding of the liquid to be examined, which is due to the initiation of crystallisation during the defined addition of a titration liquid to the liquid sample by a titration system of the measuring apparatus may then be detected by the light sensor on the basis of the increasing losses of transmission.

Preferably, a ray-form light source is used as the light source and may be produced, for example, by means of an orifice structure in an expansive light source or by the use of a laser, for example a laser diode. Furthermore, the notion of the light source in the present application is not restricted to the visible wavelength range, as a source of electromagnetic radiation outside the range which is perceptible to the human eye may also be used, for example an infrared source. Visible light, in particular in the red range of the spectrum, preferably of approximately 650 nm is preferred.

A detector system which is suitable for the light source is used as the light sensor and may be, for example, a photo transistor, a photo diode or a photo resistor. It is also conceivable to construct the photo sensor as a sensor matrix so the influence of faults may be reduced by adjusting the sensor arrangement.

According to the invention the measuring head is accordingly configured in such a way that, with the ends of the optical fibre, it is allocated to the light source and the light sensor, but may be separated therefrom. It is particularly preferable to use a measuring head which is only used for one respective urine sample in the context of a disposable measuring head. This procedure affords the advantage, in particular, that the measuring head coming into contact with the liquid sample does not have to be cleaned in a complex manner after taking a measurement. In addition, as a disposable part, it does not have to be formed so as to be suitable for a large number of measuring and cleaning steps.

With respect to geometric configuration, the measuring head is so constructed that it is immersed into a urine sample, at least until a recess in the measuring head, which is traversed by the light ray, is filled with the liquid to be measured, in particular the urine. In addition, it is preferable to arrange the light source and the light sensor in such a way that they do not come in to contact with the liquid sample, i.e. only the measuring head which touches the liquid sample becomes contaminated, although this is immaterial as it is a part which will be exchanged after one measurement in any case.

A possible configuration of the measuring head comprises an optical fibre with at least one ray-deflecting device. This enables the light source, as well as the light sensor to be positioned above the liquid level of the urine to be examined. Two ray deflectors which are at an angle of 45° to the horizontal and an angle of 90° to one another, so that a ray portion leading substantially vertically downwards, followed by a substantially horizontal ray portion and a ray portion which is directed substantially vertically upwards, is constructed in the measuring head, have proven particularly advantageous. Said recess in the measuring head is located in at least one of these ray portions, so that the ray penetrates through the liquid sample substantially freely in a specific portion and detects changes in transmission over this known path.

With an apparatus according to an invention of this type it is accordingly possible to determine, in conjunction with a metering system for the crystal formers, the amount of crystal former which leads to the initiation of crystallisation. A solution which contains a lithogenic component of the type of crystal of which the risk or crystallisation is to be determined is used as the preferred crystal former for a sample. An oxalate or phosphate solution is preferred as the crystal former for a urine sample.

For measuring the amount of crystal former required in proportion to the volume of the liquid sample, it is necessary to determine the existing amount of liquid in the urine to be examined. With a known weight of the sample vessel, this can be determined using a weighing apparatus.

Alternatively, the geodesic height of the liquid level in the sample vessel may be measured in the case of a known form of sample vessel in order to determine the volume of the measured liquid. Various apparatuses are conceivable for this purpose, for example, moisture sensors which have an open pair of electrodes between which contact is produced by the liquid to be measured, which in turn may be detected by resistance measurement. A device for determining the geodesic height of the liquid level, connected to the measuring head for transmission measurement is particularly preferred. Preferably, the measuring head is then, in turn, connected to a height adjusting apparatus which enables the measuring head to travel into the sample vessel from above and therefore to be immersed into the urine. If the height adjusting apparatus is so constructed that measurement is carried out from a known reference height from the distance covered in a vertical direction, the geodesic height of the liquid level and therefore the volume of liquid in the sampling container may be determined if the position of the liquid sensor is known.

In a particularly preferred configuration of the invention, the recess in the measuring head is used to determine the position of the liquid level of the urine sample. The initially free measuring head, i.e. there is no liquid in the recess provided by transition measurement, is moved vertically downward in the direction of the liquid level until the liquid to be examined penetrates into the recess and changes the transmission. The position of the liquid level may then be determined from the known position of the recess and the light ray travelling therein as well as the distance covered.

The measured value of the free calcium ions [Ca²⁺], required for BRI calculation, is determined in a preferred development of the apparatus for examining a urine sample by means of a suitable sensor system. In a possible configuration, a specific amount of the untreated urine sample is removed from the sample vessel for this purpose and presented to a sensor of a Ca²⁺ ions by means of a fluidics system. This may be, for example, an ion-selective field-effect transistor which comprises an ion-selective membrane. The fluidics system preferably also comprises an apparatus for introducing rinsing liquids for cleaning purposes. For calibrating the sensors, it is additionally preferred to present a calibrating solution thereto. The construction of the pumps, containers, and receivers required for this purpose and of the associated fluidic control are within the ability of a person skilled in the art.

For controlling the apparatus according to the invention, the apparatus according to the invention may comprise internal or external control units in the form either of microcontrollers or externally connected PCs, by means of which an interface for the user in the form of input units and displays may also be produced.

The measuring head preferably has a holding device for holding it on a mount of the apparatus, the holding device comprising a holding means, in particular an integrally connected component with a set breaking point, which is so constructed that the holding device may only be used once. This means that the measuring head can only be used once.

Accidental repeated use of a measuring head, which can lead to distorted results owing to impurities, is thus avoided. Repeated use of the measuring head is precluded particularly reliably if the holding means is made unserviceable as a holding means after the first use of the holding device.

In a variation, the measuring head is so constructed that it conveys the light received from the light source to the light sensor. A change in the transmission of the liquid sample to be examined may be determined in this way.

Alternatively, the measuring head may be constructed in such a way that it conveys the light received from the light source along a light path, adjacent to which the sensor is arranged, but in which the sensor is not directly arranged. A measuring head configuration of this type may be used to measure scattered light provided by the liquid sample.

The apparatus can comprise a drive device for moving the measuring head relative to the sample vessel, at least a portion of a determining device for determining the liquid level of the liquid sample being provided on the measuring head. To simplify the exchange of the sample vessel, it is advantageous in any case if the measuring head is movable relative to the sample vessel. In the above-described development, this movement may at the same time conveniently be used to determine the liquid level.

If the recess in the measuring head is a part of the determining device, the light source and the light sensor may be used for liquid level determination, together with this recess as the light intensity of the light emitted by the light source and conveyed through the measuring head changes on entering the recess into the liquid sample to be examined.

A fluid duct of the fluid system may be constructed in the measuring head. A portion of the liquid sample may then be aspirated via the measuring head for determining a parameter of the liquid sample to be examined via the fluid duct. This aspiration fluid duct is then also exchanged when the measuring head is exchanged and this makes it easier to keep the measuring apparatus clean.

The fluid duct is preferably closed by a sealing stopper which, in the measuring position of the measuring head, is penetrated by a line portion of the fluid system on the measuring head receiving side. A sealing stopper of this type allows the fluid duct to be sealed cleanly against the line portion.

In a preferred development, a fluid duct of the titration system is constructed in the measuring head. A separate titration feed pipe into the sample vessel can then be dispensed with.

Preferably, a stirrer is provided for stirring the liquid sample, the measuring head comprising at least one flow component, in particular at least one flow blade, for cooperating with the liquid sample. This allows defined mixing of the liquid sample during stirring and therefore a reproducible examination of the liquid sample.

In a variation of the measuring apparatus, the measuring system comprises a spectrometer for determining the concentration. This allows reliable, substance-selective determination of concentration.

With regard to the method, the object of the invention is achieved on the one hand, by a method for examining a liquid sample by titration, which employs the above-described measuring apparatus according to the invention. This object is achieved, on the other hand, by a method for examining a liquid sample by titration, comprising the following steps: preparation of the liquid sample, measurement of the liquid level of the liquid sample by introduction of a measuring head from above into the liquid sample, determination of the concentration of at least one type of ions in the liquid sample, feeding of a crystal former into the liquid sample and measurement of the transparency of the liquid sample after introduction. Defined, reproducible determination of the liquid parameters is thus possible.

Preferably, a new disposable measuring head is used prior to feeding. This ensures particularly readily reproducible processing conditions with regard to the measuring head. Cleaning of a used measuring head is unnecessary.

Preferably, a concentration determining sensor is cleaned and/or calibrated prior to determination of concentration. This provides defined conditions during determination of the concentration, so concentration-determining sensors which have a long-term drift tendency may also be used.

The liquid sample may be stirred before determining the concentration. This ensures defined measuring conditions, as a homogeneously distributed liquid sample is measured.

Preferably, a sample parameter is calculated from the measured values of concentration and transparency. This allows a concentration-dependent crystallisation point to be determined by a simple numerical value.

Preferably, the pH of the liquid sample is additionally determined. This provides additional information about the constitution of the liquid sample.

In addition, the temperature of the liquid sample may be determined. This may be used, in particular, to correct the determined concentration. Additional liquid parameters may also be measured using the measuring apparatus. In an advantageous development, the measuring apparatus may be constructed as a mobile laboratory for determining a large number of liquid parameters.

Liquid parameters of this type may be: the specific gravity, the content of or the presence of Na, K, Mg, NH₄, Cl, PO₄, SO₄, creatin, uric acid, leucocytes, nitride, albumin, proteins, glucose, ketone, urobilin, billirubin, urobillinrubin, erythrocytes, haemoglobin. The separation of serum proteins such as albumin, transferrin, globulins, immunoglobulins and immunoglobulin fragments.

The invention will be described in more detail with reference to the following figures which show embodiments.

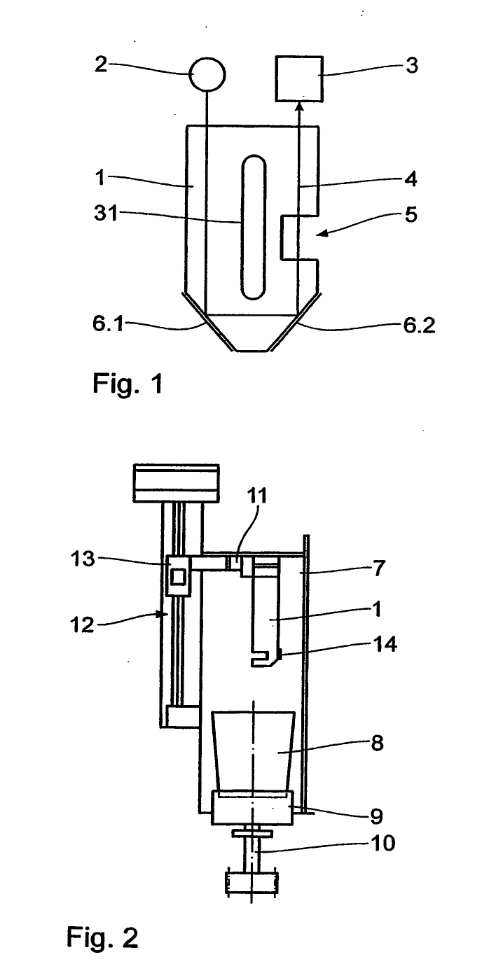

FIG. 1 shows the optical measuring system for determining the crystallisation point.

FIG. 2 shows a sample-receiving region with a sample vessel and a sampling plate as well as the optical measuring system according to FIG. 1 and the associated positioning device.

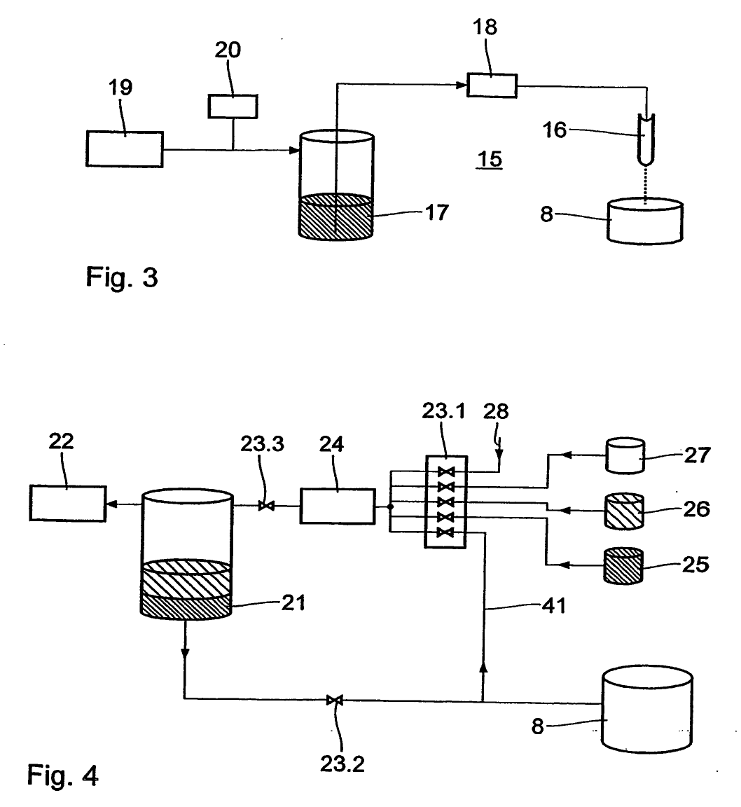

FIG. 3 shows the metering system for titration.

FIG. 4 shows the fluidics system.

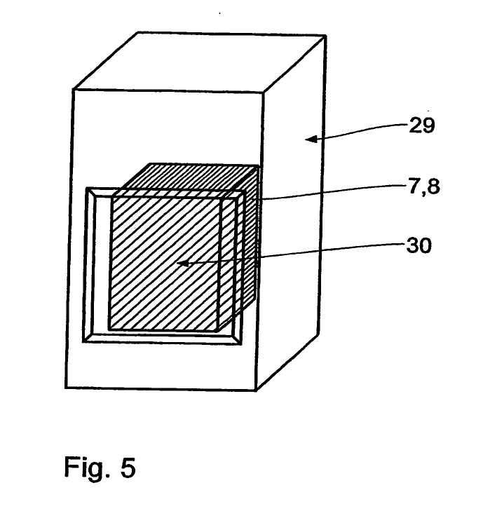

FIG. 5 is a schematic external view of the measuring appliance.

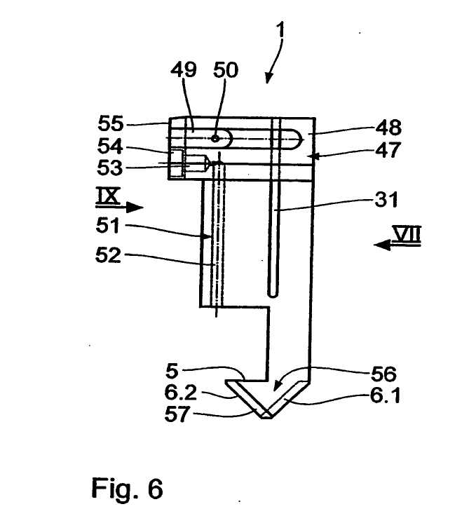

FIG. 6 is a view similar to FIG. 1 of an alternative measuring head for an optical measuring system.

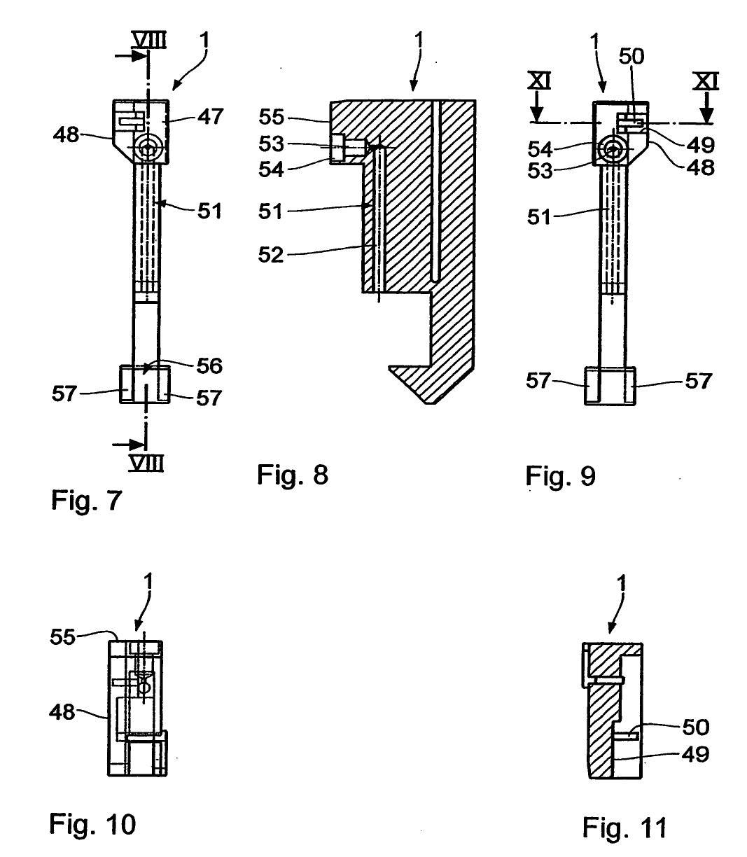

FIG. 7 is a view along sight line VII in FIG. 6.

FIG. 8 is a section along VIII-VIII in FIG. 7.

FIG. 9 is a view along sight line IX in FIG. 6.

FIG. 10 is a view of the measuring head according to FIG. 6 from above.

FIG. 11 is a section along line XI-XI in FIG. 9.

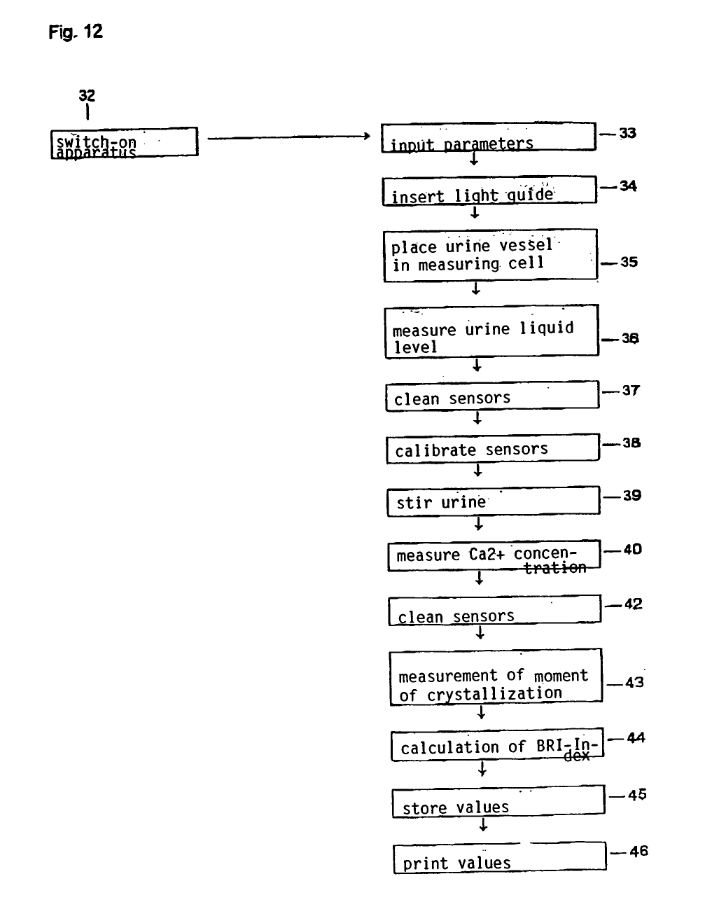

FIG. 12 is a flow chart for examining a liquid sample by titration.

FIG. 1 is a schematic view of the optical measuring system for titration for determining the crystallisation point. A measuring head 1 absorbs light from a light source 2 and conveys it to a light sensor 3. The measuring head I is formed as an exchangeable unit, in particular as a disposable unit. The measuring head also allows an arrangement of the light source 2 and of the light sensor 3 above the level of the liquid sample. The ray deflection of the measuring head required for this purpose may be achieved, for example, according to FIG. 1 by two reflective surfaces 6.1 and 6.2 which are at an angle of 45° to the vertical and at an angle of 180° to one another. Further configurations are conceivable, in particular the use of a substantially horizontal reflecting element in the bottom region of the measuring head and a V-shaped ray configuration. Preferably, the illuminating light leaves the light source with a directional component pointing vertically downwards and the light is returned to the light sensor with a directional component pointing vertically upwards. This enables the measuring head 1 to be immersed into the liquid sample without soiling the liquid source 2 and the light sensor 3.

It is preferable to introduce a substantially ray-shaped light ray into the measuring head. If this then consists of a material which is transparent to the employed wave length of the illuminating light, for example, PMMA (polymethylmethacrylate) or Makrolon (polycarbonate), which are 70-81% transparent to visible light. Any plastics materials which may be produced by injection-moulding or by machining processes may generally be used. Alternatively, the optical fibre may also consist of glass. In most cases, the influence of scattered light may be ignored for the measuring head and merely the external regions in which ray deflection occurs are then advantageously reflected. Alternative configurations of the measuring head include glass fibres or optical fibres based on polymers for ray positioning. It is also conceivable to separate regions of opposing ray positioning from one another by the geometric configuration of the measuring head. This may be effected, for example, by a recess which separates a first portion of the measuring head with downwardly directed ray positioning from a second part in which ray positioning is directed upwards. Owing to the formation of an interface from the material of the measuring head to the open region in the recess, crosstalk between the individual regions of ray positioning in the measuring head, which reduces the accuracy of measurement, is avoided. A free region of this type is sketched in FIG. 1.

For taking transmission measurements, it is necessary to interrupt the optical fibre over a specific irradiation distance. According to FIG. 1, a recess 5 in which the liquid to be examined penetrates in the immersed state should preferably be provided in the measuring head. This recess 5 and the liquid located therein are then traversed by the released light ray. This is then introduced into the measuring head or into the optical fibre of the measuring head again and presented to the light sensor 3.

FIG. 2 is a longitudinal section through the sample-receiving region 7 for receiving a sample vessel 8 positioned on a sample plate 9. The sample plate 9 is so positioned that it provides a support which is as horizontal as possible for the sample vessel 8, for determining the position of the liquid level as exactly as possible. The sample plate 9 is also allocated a motor 10 to allow a rotational movement for mixing the liquid sample in the sample vessel 8. In a preferred configuration, the sample plate 9 is driven indirectly, and this may be achieved, for example, by a magnetic drive. This measure enables the sample-receiving region 7 to be sealed from the external region for reasons of hygiene. In particular, the region 7 may be worked out on the housing side in such a way that the escape of liquids into the interior of the appliance is totally precluded.

The measuring head 1 for transmission measurement is located above the sample vessel 8 in the sample-receiving region 7. It is fixed on a measuring head carrier 11 and can preferably be exchanged by mere manual interventions in the sense of a disposable article. The light source 2 which remains permanently on the measuring system and the light sensor 3 are preferably arranged in the measuring head 11. In a preferred configuration, moreover, the measuring head carrier is allocated a marking and/or detection system by means of which an already used measuring head 1 may be detected or which marks a measuring head as used when it is attached or is immersed into the liquid sample. In a possible configuration, two plastic pins which may be broken off and which actuate a switch when inserted into the measuring head carrier are arranged on the measuring head. The pins break off so that the switches cannot be triggered again if they are re-used. The switch transmits two signals to the electronics. The first signal has a short duration and the second signal is applied throughout the measuring process and at the same time serves to check the position of the measuring head.

For positioning the measuring head 1, the measuring head carrier 11 is connected to a positioning system 12, which substantially allows a vertical movement for immersing the measuring head 1 into the liquid sample.

For carrying out the investigation, it is necessary to determine the liquid volume of the liquid sample in the sample vessel 8. This may be effected in various ways. On the one hand, it is possible to derive the volume by determining the weight of the filled sample vessel 8. For this purpose, the sample plate 9 can be allocated a weighing unit. Alternatively, if the shape of the sample vessel is known, the volume may be measured by determining the geodesic height of the liquid level of the liquid sample in the sample vessel 8. A configuration in which a liquid detection system 14 is connected to the measuring head, and the positioning system 12 for the measuring head is allocated a position measuring system 13 is particularly preferred. Starting from a specific reference point, the vertical distance covered by the measuring head 1 until it reaches the liquid level may be used to determine the volume of the liquid sample in the sample vessel 8. In a possible configuration, the position measuring system 13 comprises contact switches for the reference position. These may be formed, for example, as Hall-effect sensors.

In addition, the distance covered by the measuring head during positioning may be determined by a suitable sensor, for example a rotational speed sensor or a linear scale. If a stepping motor is selected as the drive, it is unnecessary to use additional sensors to determine the movement.

FIG. 3 is a schematically simplified view of the metering system allocated to the titration system for feeding a crystal former into the liquid sample. A 0.04 N ammonium oxalate solution is preferably added as the crystal former for effecting calcium oxalate crystallisation. If calcium phosphate crystallisation in human urine is to be examined instead, the ammonium oxalate solution is replaced by a phosphate solution. In a possible configuration of the metering system, the controlled, volumetrically precise addition of the crystal former is effected by applying a precisely predetermined pressure to a resource container in which the crystal former is located. This is produced by a pump 19 and monitored by a pressure sensor 20. Using an extraction tube immersed into the liquid under pressure in the resource container 17, the crystal former is conveyed by the filter 18 to a nozzle 16, from which the controlled addition of the crystal former into the sample vessel 8 and the liquid sample located therein then takes place. Alternatively, the crystal former can be introduced by means of a metering pump, not shown in FIG. 3, rather than applying pressure to the resource container 17. Other volumetrically precise methods of addition may also be selected for carrying out the measuring method. Preferably, the liquid sample will be stirred during the feeding process. This can be effected by rotating the sample vessel, the measuring head 1 immersed into the liquid sample then acting as a flow breaker.

FIG. 4 shows the fluidics system of the measuring apparatus in a schematically simplified manner. It is used for examining further parameters of the liquid sample, the content of free calcium ions being of particular interest in the case of urine. In addition, the urine temperature and the pH can also be determined. For this purpose, a specific fraction of the liquid sample is removed from the sample, automatically or by the user, and conveyed to the fluidics system, the lines of this fluidics system having a vacuum, so the liquid can be transported to the intermediate container 21 by switching the valves 23.1, 23.2 and 23.3. The necessary vacuum is produced therein by an air pump 22. Owing to this measure, both the liquid sample and further liquids, for example a first calibrating solution 27 and a second calibrating solution 26 as well as a cleaning solution 25 can be conveyed through the sensor block 24. It is also possible to ventilate the ducts for cleaning purposes via the air supply 28. As an alternative to using a vacuum in the fluidics system, a pump, for example, a hose pump, may be used for transporting the liquid. This configuration is not shown in FIG. 4.

Ion-selection field-transistors (ISFET) of which the ion selectivity is brought about by the choice of a suitable membrane, are preferably used in the sensor block 24. A pH sensor and a temperature sensor may additionally also be used as the sensors.

FIG. 4 does not show the details of signalling and control. The apparatus may be controlled, for example, by one or more microcontrollers, which can also process the sensor signals. The measuring system may be formed as an autarchic unit, but it is also conceivable to outsource specific control functions and functions, for example, for forming a user interface or for printing functions, to an external control unit or to a PC.

FIG. 5 is a general view of the measuring apparatus. A housing, in which the transmission measuring system with the exchangeable measuring heads and the metering system for carrying out titration measurements are accommodated is shown. The apparatus further comprises a fluidics system for sampling with further sensor elements, in particular for measuring the content of free calcium ions and the pH and the temperature of the liquid sample. Only the sample-receiving region for introduction of a sample vessel is accessible to a user. This sample-receiving region is preferably constructed from stainless steel to allow easy cleaning. A configuration in which at least portions of the sample-receiving region 7 are covered with a layer of titanium oxide is also preferred. This has an anti-bacterial effect, in particular with conjunction with UV-irradiation, so automatic disinfection of the sample-receiving region can be carried out. If a UV light source is integrated in the region of the sample-receiving region 7 for this purpose, it is preferable to close the sample-receiving region with a UV-tight door element to protect the user.

In addition to use of the apparatus according to the invention for examining human urine, in particular for determining the BRI, it is possible to examine a large number of different liquids, in which the transmission properties are changed by the addition of a substance and for which quantities change in transmission is to be determined quantitatively.

FIG. 12 is a flow chart for carrying out the method for examining a liquid sample by titration in the example of a sample of human urine.

The measuring apparatus is switched on in a preparatory step 32. Starting parameters, for example, an identification code of the patient, are then input in an input step 33 via an alphanumeric keyboard. The user can control the input parameters via an LCD display of the measuring apparatus. After the parameters have been input, the measuring head 1 is inserted into a corresponding measuring head socket of the measuring apparatus in an assembly step 34. The measuring head 1 comprises a contact pin (not shown) which cooperates with a corresponding contact in the socket of the measuring apparatus. If the measuring head is incorrectly positioned in the socket, the measuring apparatus automatically emits an error message on the LCD display. The sample vessel 8 is then placed on the sample plate 9 with the liquid sample and the door element 30 is subsequently closed in a readiness step 35. The closed position of the door element 30 is checked by the measuring apparatus via corresponding contacting. If the door element 30 is not correctly closed, the measuring program emits an error message. Measurement is subsequently started automatically. The liquid level of the liquid sample is subsequently measured in a level measuring step 36. For this purpose, the measuring head I is driven from a defined zero position by means of the positioning system 12, which comprises a threaded spindle from above into the sample vessel with the liquid sample. Using the position measuring system 13, the distance covered is measured via the number of revolutions of the threaded spindle. As soon as the recess 5 is wetted by the liquid sample, in other words, as soon as the lower edge of the recess 5 is at the height of the liquid level, the intensity of the ray falling onto the light sensor 3 changes as, on the one hand, the refractive indices at the interfaces of the recess 5 change and, on the other hand, the light ray through the liquid is at least partially attenuated. The change in intensity caused by the attainment of the liquid level is detected by the light sensor 3. As soon as a defined change has occurred, for example as soon as the measured intensity attains less than 98% of the starting intensity, the instantaneous position of the threaded spindle is detected by the position measuring system 13. In this way, the liquid level of the liquid sample in the sample vessel 8 can be determined exactly and conclusions can be drawn about the amount of sample from the height of the liquid level and the then known liquid volume in the sample vessel 8.

A cleaning step 37 now takes place in preparation for concentration determination. For this purpose, the cleaning solution 25 is temporarily guided past the sensor block 24. The cleaning solution 25 then remains for a short time in the fluidics system, so bacteria can be destroyed. This passing and standing of the cleaning solution 25 is repeated a plurality of times during the cleaning step 37. If the measuring apparatus is not used for a prolonged period, it may also be necessary to clean further line regions of the fluidics system and not just the sensor block 24.

The sensor block 24 is calibrated in a subsequent calibration step 38. For this purpose, a Ca ion sensor and the pH sensor of the sensor block 24 are brought into contact with the first calibration solution 27. The first calibration solution 27 is drawn past the sensors of the sensor block 24 for a short time. As soon as the measured values of the sensor are stable, as detected by the measuring program by means of a slight variation in successive measured values, the measured values are stored. This process is subsequently repeated with the second calibration solution 26 within the calibration step 38. The measurement program determines the necessary calibration parameters for Ca-concentration determination and pH determination from the measured values of the sensor determined in this way, from the two different calibration liquids. The subsequently collected measured values are collected using the calibration parameters contained.

The liquid sample in the sample vessel 8 is subsequently stirred in a stirring step 39. For this purpose, the sample plate 9 with the sample vessel 8 is set into uniform rotation about the vertical axis of the sample vessel 8. The measuring head 1 is lowered further into the liquid sample and therefore acts as a stirrer during the stirring step 39.

In a subsequent concentration-determining step 40, a portion of the liquid sample from the sample vessel 8 is aspirated via a supply line 41 (CF. FIG. 4) from the sample vessel 8 into the sensor block 24. The aspirated sample volume is then passed by the sensor block 24 for a short time. After the waiting for an adjustment period of the Ca sensor of the sensor block 24, the Ca²⁺-concentration is measured with the Ca sensor of the sensor block 24. The pH is measured with the pH sensor of the sensor block 24. The temperature is measured using the temperature sensor. The temperature value is used to correct the Ca-concentration value by means of the measurement program.

A further cleaning step 42 for the sensor block 24 now takes place. The cleaning step 32 corresponds to the cleaning step 37.

In a crystallisation measuring step 43, the sample vessel 8 is initially rotated uniformly by means of the motor 10 of the sample plate 9 in a preparatory manner, so that a thoroughly mixed liquid sample is obtained. The light source 2 is then switched on and the intensity of the light arriving at the light sensor 3 from the light source 2 is measured. At specific time intervals, for example at respective intervals of one minute or also at intervals of a few seconds, a specific amount of ammonium oxalate is injected or titrated from the resource container 17 via the metering system 15. The measurement program calculates the total injected amount of ammonium oxalate from the previously known concentration of the ammonium oxalate solution. Titration is continued during the crystallisation measuring step 43 until calcium oxalate crystallisation occurs. The crystallisation point can be detected by clouding of the liquid sample and an associated lower light intensity at the light sensor 3. The instant of titration, for example, at which the measured light intensity at the light sensor 3 is 98% of the light intensity at the beginning of titration can be determined as the crystallisation point. During the crystallisation measuring step 43, the amount of added ammonium oxalate required for achieving the crystallisation point can be measured in this way with an accuracy of, for example, ±0.2 ml at a titration rate of 40 mmol/l via the reduction in the light intensity measured at the light sensor 3.

The BRI index is subsequently calculated in a calculation step 44. For this purpose, the amount of oxalate is initially calculated from the amount of liquid in the liquid sample and the amount of ammonium oxalate added up to the crystallisation point. The BRI index is obtained in the manner mentioned at the beginning of the description as the quotient of the Ca²⁺-concentration determined in the concentration-determining step 40 divided by the amount of oxalate. In medical circles, the amount of oxalate is understood to be the concentration of oxalate (Ox²⁻) based on a sample volume of 200 ml.

In a subsequent storage step 45, the following values in particular, are then stored: the patient's identity code, the date, the time, the measured temperature, the measured Ca²⁺-concentration, the measured pH, the BRI index calculated form the measured data, the respective individual values measured by the sensors of the sensor block 24 and any error messages that have appeared. A compact flash card, in particular, is used as the storage medium. For maintenance or monitoring purposes, the storage medium can be transferred to a maintenance or monitoring computer via a read-out interface.

The desired data of the measured, calculated or stored values are printed out in a final printing step 46. For this purpose, the stored information can be transferred to a computer, for example via an USB-interface. The data can be further processed there.

A measuring head which is an alternative to the measuring head 1 shown in FIG. 1 is shown in FIG. 6 to 11. Components of this measuring head corresponding to those which have already been described herein before with reference to FIG. 1 to 5 or with reference to the description of the method according to FIG. 12 bear like reference numerals and will not be described again in detail. In the upper holding portion 47 in FIG. 6, in a lateral wall 48, the alternative measuring head 1 has a horizontally extending holding groove 49 which is open to the left in FIG. 6. The holding groove 49 is a component of a holding device for holding the alternative measuring head 1 in a socket of the measuring apparatus. The socket has a holding rib (not shown in the drawing) which is complementary to the holding groove 49. A holding pin 50 which is arranged in the holding groove 49 and extends horizontally in FIG. 6 and transversely to the extension of the holding groove 49 is a further component of the holding device. In the socket of the measuring apparatus, the holding pin 50 cooperates with a holding opening of the measuring apparatus corresponding thereto.

A fluid duct 51 which communicates fluidically with the supply line 41 of the fluidics system in the assembled alternative measuring head 1 is constructed in the alternative measuring head 1. The fluid duct 51 extends in a first duct portion 52 from an upper limiting wall, which is horizontal in FIG. 6, of the recess 5 upwards into the holding potion 47. The fluid duct 51 has a 900 deflection here, and initially narrows after this deflection and then widens conically in a second duct portion 53. Via a subsequent stepped enlargement 54, the second duct portion opens from a lateral wall 55, on the left of FIG. 6 of the alternative measuring head 1.

Before the alternative measuring head 1 is inserted, the fluid duct 51 is closed by a sealing stopper (not shown) which is inserted tightly into the enlargement 54. In the measuring position of the alternative measuring head 1, in which the measuring head 1 is received in the socket of the measuring apparatus, the sealing stopper is penetrated by a line portion of the supply line 41 of the fluid system on the measuring head receiving side. This line portion is formed by a conventional commercial injection needle. Once the sealing stopper with the line portion has been pierced, the sealing stopper seals the line portion against the internal wall of the enlargement 54, producing a fluid connection between the fluid duct 51 and the supply line 41 that is sealed from the exterior.

In a deflection portion 56 in the lower region, in FIG. 6, the two ray deflectors 6.1, 6.2 are directly adjacent to one another so that the deflection region 56 has the form of an inverted roof edge. A flow blade 75 is formed integrally onto the two deflectors 6.1, 6.2 so as to project on respective sides. The two flow blades 57 act as flow components which cooperate with the liquid sample during stirring of the liquid sample for thorough mixing purposes.

During insertion of the alternative measuring head 1 into the measuring position, the holding pin 50 latches into the associated opening in the socket of the measuring apparatus 1. The opening is configured in such a way that, as the measuring head is removed after measurement, the holding pin 50 breaks away from the holding portion 57 at a set breaking point. As the holding pin 50 has a holding function, the alternative measuring head cannot be re-used after it has broken away.

In the alternative measuring head 1, the recess 5 is used to determine the liquid level of the liquid sample, as described herein before in conjunction with the flow chart in FIG. 12. Together with the positioning system 12, the position measuring system 13, the light source 2, the light sensor 3 and the steel deflectors 6.1, 6.2, therefore, the socket 5 forms a determining device for determining the liquid level of the liquid sample.

The two variations of the measuring head shown on the one hand, in FIG. 1 and, on the other hand, in FIG. 6 to 11, are each constructed in such a way that they convey light received from the light source 2 directly to the light sensor 3. In a further variation of the measuring head (not shown), the measuring head is so configured that it conveys the light received from the light source 2 along a light path, adjacent to which the light sensor 3 is arranged, the sensor not being arranged directly in the light path. In this case, the light sensor 3 does not measure changes of transmission produced by the incipient crystallisation of the liquid sample, but changes in the resultant scattered light intensity. The light sensor 3 can, for example, be arranged in such a way that it does not initially measure a light intensity from the light source 2 in the case of a non-scattering liquid sample. Only due to the scattering produced as a result of the incipient crystallisation does scattered light pass to the light sensor 3 which can then be correspondingly sensitive in design so that it can then already detect small amounts of scattered light.

In a further variation of the measuring head (not shown), a fluid duct of the metering or titration system 15 is constructed with the nozzle 16 in the measuring head.

In a further variation of the measuring head, a spectrometer is used to determine the Ca²⁺-concentration in the concentration-determining step 40, rather than the sensor block 24. For this purpose, the portion of the liquid sample, of which the Ca²⁺-concentration is to be determined, is permeated with light of different wavelengths, conclusions about the presence of Ca-ions in a corresponding concentration being drawn form the absorption of the liquid at specific wavelengths.

### LIST OF REFERENCE NUMERALS

1 Measuring head
2 Light source
3 Light sensor
4 Light path
5 Recess
6.1, 6.2 Ray deflector
7 Sample-receiving region
8 Sample vessel
9 Sample plate
10 Motor
11 Measuring head carrier
12 Positioning system
13 Position measuring system
14 Liquid detection system
15 Metering system
16 Nozzle
17 Resource container
18 Filter
19 Pump
20 Pressure sensor
21 Intermediate container
22 Air pump
23 Valves
24 Sensor block
25 Cleaning solution
26 First calibration solution
27 Second calibration solution
28 Air supply
29 Housing
30 Door element
31 Open region in measuring head
32 Preparatory step
33 Input step
34 Assembly step
35 Readiness step
36 Level measuring step
37 Cleaning step
38 Calibration step
39 Stirring step
40 Concentration-determining step
41 Supply line
42 Cleaning step
43 Crystallisation measuring step
44 Calculation step
45 Storage step
46 Printing step
47 Holding portion
48 Lateral wall
49 Holding groove
50 Holding pin
51 Fluid duct
52 First duct portion
53 Second duct portion
54 Enlargement
55 Lateral wall
56 Deflecting portion
57 Flow blades

1-38. (canceled)

39. An apparatus for examining a liquid by titration, comprising
1.1 a light source (2);
1.2 a light sensor (3);
1.3 a measuring head (1) which is to be immersed into the liquid sample to be examined, with an optical fibre which receives and conveys light from the light source, wherein the measuring head (1) comprises a recess (5) with an interruption in the optical fibre into which the liquid to be examined penetrates when a measuring head (1) is immersed;
1.4 wherein the measuring head (1) may be separated from the light source (2) and the light sensor (3); and
1.5 a titration system for the defined addition of a titration liquid into the liquid sample;
and further comprising a drive device (12) for moving the measuring head (1) relative to the sample vessel (8), at least a part of a determining device (2, 3, 5, 6.1, 6.2, 12, 13) being provided for determining the liquid level of the liquid sample.

40. An apparatus for examining a liquid sample according to claim 39, wherein the apparatus further comprises a measuring system for measuring the pH of the liquid sample.

41. An apparatus for examining a liquid sample according to claim 39, wherein the apparatus further comprises a temperature measuring system for measuring the temperature of the liquid sample.

42. An apparatus for examining a liquid sample according to claim 39, wherein the apparatus further comprises a fluidics system for the defined removal of an amount of the liquid to be examined.

43. An apparatus for examining a liquid sample according to claim 42, wherein the fluidics system comprises an apparatus for calibrating with at least one calibration liquid.

44. An apparatus for examining a liquid sample according to claim 42, wherein the fluidics system comprises cleaning means.

45. An apparatus for examining a liquid sample according to claim 39, wherein an exchangeable sample vessel (8) is provided for receiving the liquid samples.

46. An apparatus for examining a liquid sample according to claim 45, wherein the apparatus comprises a sample-receiving region (7) in which the sample vessel (8) can be arranged below the measuring head (1).

47. An apparatus for examining a liquid sample according to claim 46, wherein the sample-receiving region (7) is constructed from a material selected from the group consisting of stainless steel, titanium oxide, and stainless steel with titanium oxide coating.

48. An apparatus for examining a liquid sample according to claim 46, wherein the sample-receiving region (7) comprises a device which disinfects it using UV light.

49. An apparatus for examining a liquid sample according to claim 45, wherein a rotatable sample plate (9) with an indirect drive is provided for the sample vessel (8).

50. An apparatus for examining a liquid sample according to claim 39, wherein the measuring head (1) is a disposable article.

51. An apparatus for examining a liquid sample according to claim 50, wherein a device which detects a measuring head (1) that has already been used is provided.

52. An apparatus according to claim 39, wherein the measuring head (1) comprises a holding device (49, 50) for holding on a socket of the apparatus, the holding device comprising a holding means (50), which is constructed in such a way that the holding device (49, 50) can only be used once.

53. An apparatus according to claim 52, comprising an integral connection component with a set breaking point as a holding means (50).

54. An apparatus according to claim 39, wherein the measuring head (1) is constructed in such a way that is conveys the light received from the light source (2) to the light sensor (3).

55. An apparatus according to claim 39, wherein the measuring head (1) is constructed in such a way that it conveys the light received by the light source along a light path, adjacent to which the sensor is arranged, but in which the sensor is not directly arranged.

56. An apparatus according to claim 39, wherein the recess (5) represents a part of the determining device (2, 3, 5, 6, 6.1, 6.2, 12, 13).

57. An apparatus according to claim 42, wherein the fluid duct (51) of the fluidics system is constructed in the measuring head (1).

58. An apparatus according to claim 57, wherein the fluid duct (51) is closed via a sealing stopper which is penetrated by a line portion (41) of the fluidics system on the measuring head receiving side in the measuring position of the measuring head (1).

59. An apparatus according to claim 39, wherein a fluid duct of the titration system is constructed in the measuring head (1).

60. An apparatus according to claim 39, further comprising a stirring device (9, 10, 57) for stirring the liquid sample, the measuring head (2) comprising at least one flow component for cooperating with the liquid sample.

61. An apparatus according to claim 60, further comprising at least one flow blade (57) as a flow component.

62. A method for examining a liquid sample by titration, wherein an apparatus for examining a liquid sample by titration in accordance with claim 39 is used.

63. A method for examining a liquid sample by titration, comprising the following steps:
providing (35) the liquid sample;
measuring (36) the liquid level of the liquid sample by driving a measuring head (1) into the liquid sample from above;
determining (4) the concentration of at least one type of ion of the liquid sample; and
performing (43) crystallisation measurement by feeding a crystal former into the liquid sample and measuring crystal formation.

64. A method according to claim 63, wherein crystal formation takes place by measuring the transparency of the liquid sample after feeding.

65. A method according to claim 63, further comprising the step of inserting (34) a new disposable measuring head (1) prior to feeding.

66. A method according to claim 63, further comprising the step of cleaning (37) a concentration-determining sensor (24) prior to concentration determination (40).

67. A method according to claim 66, further comprising the step of calibrating (38) a concentration-determining sensor (24) prior to concentration determination (40).

68. A method according to claim 63, further comprising the step of stirring (39) the liquid sample prior to concentration determination (40).

69. A method according to claim 63, further comprising the step of calculating (44) a sample parameter from the measured values with the concentration and the transparency.

70. A method according to claim 63, further comprising the step of determining the pH of the liquid sample.

71. A method according to claim 63, further comprising the step of determining the temperature of the liquid sample.

72. A measuring head (1) for use in an apparatus according to claim 39, comprising a recess (31) by which an interface from the material of the measuring head (1) to the open region in the recess (31) is formed such that crosstalk between individual regions of ray positioning in the measuring head (1), which reduces the accuracy of measurement, is avoided.
